(19) United States
(12) Patent Application Publication
(10) Pub. No.: US 2022/0414607 A1
(43) Pub. Date: Dec. 29, 2022

(54) System and Method for Scheduling, Canceling and Rescheduling Appointments

(71) Applicant: Jacqueline Santana Jacques, Santa Cruz, CA (US)

(72) Inventor: Jacqueline Santana Jacques, Santa Cruz, CA (US)

(21) Appl. No.: 17/852,929

(22) Filed: Jun. 29, 2022

Related U.S. Application Data
(60) Provisional application No. 63/216,207, filed on Jun. 29, 2021.

(51) Int. Cl. G06Q 10/10; H04L 51/046

(52) U.S. Cl. CPC G06Q 10/1095; H04L 51/046

(57) ABSTRACT

The present invention relates to an appointment scheduling system and application for businesses and customers. The system enables customers to control their schedules to reserve, book, cancel, or reschedule their appointments while notifying the customers on a waitlist when an appointment window is available. The system enables businesses to add customers in the waitlist when open timeslots are available and thus ensures that empty appointment timeslots are consistently filled with customers. The system is configured to send appointment reminders to customers and enables businesses to create personalized appointment timeslots.

### CROSS-REFERENCE TO RELATED APPLICATION

The present application claims priority to, and the benefit of, U.S. Provisional Application No. 63/216,207, which was filed on Jun. 29, 2021 and is incorporated herein by reference in its entirety.

### FIELD OF THE INVENTION

The present invention relates generally to the field of booking or scheduling and management of appointments. More specifically, the present invention relates to a computer-implemented method and system for customers and businesses to coordinate booking or scheduling and canceling appointments, events, reservations, and more in one application or platform. The system enables automatic appointment invites to go out from the business, putting customers on a waitlist, and notifying customers on the waitlist about open timeslots. The system provides flexibility to businesses with scheduling of appointments and prevents loss of timeslots due to cancellation and rescheduling of the appointments by customers. Accordingly, the present disclosure makes specific reference thereto. Nonetheless, it is to be appreciated that aspects of the present invention are also equally applicable to other like applications, devices, and methods of manufacture.

### BACKGROUND

By way of background, service-based businesses generally schedule the maximum number of client appointments in order to maximize their profits. Businesses usually schedule their client appointments in a manner such that none of them overlaps each other and all the timeslots are properly utilized as well. Generally, this task is performed by a specialist such as a manager who manages different client appointments and ensures maximum number of customers are able to reach the services of the business.

However, it can be extremely tiring and time consuming to manually manage the client appointments. Also, with the manual work, a large risk of errors can result. There can be overlapping in the client appointments, missing out on client information, empty timeslots, and more, that not only impacts the reputation of the business but also takes a toll on the income of the business.

Also, customers with appointment times at different businesses may also need to cancel, book, or reserve a different time for their appointment as per their availability and desire. Some businesses allow the customers to cancel, book, or change timeslots for appointments on a long-term basis, as sudden (i.e. lack of notice) appointment management is not possible for most of the businesses. However, it is not always possible to give a long-term notice for changes in appointments and with such restrictions, individuals may be reluctant in availing services from such businesses. Some businesses allow the customers to change appointments on a short-term notice; however, in such situations the change in appointment schedules should be planned with as much notice as possible before the timeslot, otherwise loss of income results to the businesses if the appointment timeslot is not filled with other clients. The unfilled appointment slots/windows lead to wasted profitability for the businesses.

Further, some clients may not have knowledge of open/available appointment windows for any business and may lose the opportunity to book the appointment for the business. This wastes the time of the customers and business as well. There is a need for a way to get prior knowledge about availability of appointment windows/slots for any business, so that customers can quickly book their appointments and the appointment slots do not remain unfilled.

Currently, all the tasks related to appointment scheduling and management is performed manually and the businesses may not have a way to fill and cancel appointments efficiently and quickly.

Therefore, there exists a long felt need in the art for a method of scheduling and managing client appointments for different businesses in an efficient manner. There is also a long felt need in the art for an appointment scheduling application that enables the customers to easily book, cancel, and/or change the appointment timeslot for any business without any hassles of long-term or short-term notices to businesses. Additionally, there is a long felt need in the art for an appointment management application that eliminates the need to manually work on managing and scheduling of client businesses and therefore eliminates the possibility of manual errors. Moreover, there is a long felt need in the art for an appointment scheduling application that ensures no appointment slots remain unfilled and no two appointment slots are overlapped. Further, there is a long felt need in the art for an appointment scheduling application that notifies customers of available timeslots and allow them to easily book the appointments with businesses. Furthermore, there is a long felt need in the art for an appointment scheduling and management application that can be used by both clients and businesses. Finally, there is a long felt need in the art for an appointment scheduling and management application that prevents businesses from having open appointment windows/slots and wasting time to fill the schedule and/or losing profits (i.e. missing revenue).

The subject matter disclosed and claimed herein, in one embodiment thereof, comprises a computer-implemented method for providing appointment scheduling services to registered customers and businesses. The method comprising the steps of receiving, at a server, registration data of a plurality of service providing businesses; receiving, at the server, registration data of a plurality of customers; receiving, at the server from a registered business, appointment timeslots information; receiving, at the server from a registered customer, appointment booking or scheduling for a timeslot from one of said appointment timeslots; sending, by the server, a notification to the customer of being added to a waitlist; sending, by the server, a notification to the customer after being added to the waitlist of an available timeslot; receiving, at the server from the customer, a confirmation of appointment booking or scheduling on the available timeslot; sending, by the server, a notification to the business of a confirmed appointment booking or scheduling and sending, by the server, appointment reminders to the registered customer wherein the customer is charged with a penalty for missing the booked appointment.

In this manner, the online appointment management system and associated application of the present invention accomplish all of the forgoing objectives and provide users with a system that can be accessed through a mobile smartphone application or a website by customers and businesses to coordinate booking or scheduling and canceling appointments, events, reservations, and more. Businesses can create timeslots which can be used by customers for booking or scheduling appointments. Customers are put on a waitlist when timeslots are not available and are notified when open timeslots are available, thus, ensuring that customers get the earliest available timeslots and businesses do not have any empty timeslots.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer-implemented method for providing appointment scheduling services to registered customers. The method comprising the steps of receiving, at a server, registration data of a plurality of service providing businesses; receiving, at the server, registration data of a plurality of customers; receiving, at the server from a registered business, an event detail and associated appointment timeslots information; receiving, at the server from a registered customer, appointment booking or scheduling for a timeslot from one of said appointment timeslots; sending, by the server, a notification to the customer of being added to a waitlist; sending, by the server, a notification to the customer after being added to the waitlist of an available timeslot; receiving, at the server from the customer, a confirmation of appointment booking or scheduling on the available timeslot and sending, by the server, a notification to the business of a confirmed appointment booking or scheduling.

In yet another embodiment, the method further comprising, receiving, at the server from the customer, an appointment cancellation request; sending, by the server to the business, a notification of the appointment cancellation of the customer; thereby making the canceled timeslot as an open and available timeslot for appointment booking or scheduling; charging a customer, by the server, a penalty for missing a booked appointment.

In yet another embodiment, the computer-implemented method further comprising storing, by the server, registered customer information in a customer database; storing, by the server, registered businesses information in a business database; sending, notifications about available timeslots and waitlist to customers using a notification module.

In yet another embodiment, a computer-based system for customers and businesses to coordinate appointment booking or scheduling is disclosed. The system includes a server for facilitating automatic appointment booking or scheduling, cancellation, and rescheduling and the server comprising a customer database for storing registration information of a plurality of registered customers; a business database for storing registration information of a plurality of registered businesses; an appointment database for maintaining real time information of appointments being booked by the customers; and, a notification module for sending automatic reminders to customers for appointments, notifications of waitlist, and notifications of open timeslots.

In yet another embodiment, a computer-readable storage medium storing non-transitory computer-executable program instructions, wherein when executed by a computing device, the non-transitory computer-executable program instructions cause a processor of the computing device to perform operations comprising receiving, from a customer, an appointment booking or scheduling request; transmitting, to a server, the appointment booking or scheduling request; and sending, from the server, a notification of booking or scheduling confirmation.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of an appointment scheduling system of the present invention in accordance with the disclosed architecture;

FIG. 2 illustrates an exemplary user interface/web interface that a customer might see while interacting with the software application in accordance with the disclosed architecture;

FIG. 3 illustrates another exemplary user interface/web interface displayed on the online scheduling application to a customer for booking or scheduling an appointment in accordance with the disclosed architecture;

FIG. 4 illustrates an exemplary user interface of the online scheduling application for interaction with a customer to confirm an appointment booking or scheduling in accordance with the disclosed architecture;

FIG. 5 illustrates another exemplary user interface of the application enabling a user to book an appointment timeslot in accordance with the disclosed architecture;

FIG. 6A illustrates an exemplary user interface providing capability of adding a customer to a waitlist for appointment booking or scheduling in accordance with the disclosed architecture;

FIG. 6B illustrates another user interface providing options for the customers to modify a pending appointment after being added to a waitlist in accordance with the disclosed architecture;

FIG. 7 illustrates an exemplary user interface of the online scheduling application enabling a customer to cancel and reschedule a booked appointment in accordance with the disclosed architecture;

FIG. 8 illustrates an exemplary user interface shown by the application for a business to set business hours for appointments in accordance with the disclosed architecture;

FIG. 9 illustrates another user interface for a user to interact with the online scheduling application for creating specific events and timeslots for appointments in accordance with the disclosed architecture;

FIG. 10 illustrates a user interface for a business to view appointment calendar and status of customer appointments in accordance with the disclosed architecture;

FIG. 11 illustrates a flow diagram depicting a process of working of the online scheduling system of the present invention in accordance with the disclosed architecture;

FIG. 12 illustrates a flow diagram depicting a process of appointment confirmation and reminders to customers in accordance with the disclosed architecture; and

FIG. 13 depicts an example computing device for implementing the online appointment scheduling application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a method of scheduling and managing client appointments for different businesses in an efficient manner. There is also a long felt need in the art for an appointment scheduling application that enables the customers to easily book, cancel, and/or change the appointment timeslot for any business without any hassles of long-term or short-term notices to businesses. Additionally, there is a long felt need in the art for an appointment management application that eliminates the need to manually work on managing and scheduling of client businesses and therefore eliminates the possibility of manual errors. Moreover, there is a long felt need in the art for an appointment scheduling application that ensures no appointment slots remain unfilled and no two appointment slots are overlapped. Further, there is a long felt need in the art for an appointment scheduling application that notifies customers of available timeslots and allow them to easily book the appointments with businesses. Furthermore, there is a long felt need in the art for an appointment scheduling and management application that can be used by both clients and businesses. Finally, there is a long felt need in the art for an appointment scheduling and management application that prevents businesses from having open appointment windows/slots and wasting time to fill the schedule and/or losing revenue.

The present invention, in one exemplary embodiment, is a computer-based system for customers and businesses to coordinate appointment booking or scheduling. The system includes a server for facilitating automatic appointment booking or scheduling, cancellation, and rescheduling and the server comprising a customer database for storing registration information of a plurality of registered customers; a business database for storing registration information of a plurality of registered businesses; an appointment database for maintaining real time information of appointments being booked by the customers; and, a notification module for sending automatic reminders to customers for appointments, notifications of waitlist, and notifications of open timeslots.

Embodiments of the present invention can be used in conjunction with various devices, for example, a personal computer (PC), a desktop computer, a laptop, a notebook computer, a tablet, a server computer, a handheld computer, any handheld electronic device, a personal digital assistant (PDA) device, a handheld PDA device, an on-board device, a mobile or portable device, a non-mobile or non-portable device, a display unit, a monitor, a wireless communication device, and more.

Although embodiments of the invention are not limited in this regard, the term “user” as used herein may include, for example, a customer, a business, a service provider, a service consumer, or the like.

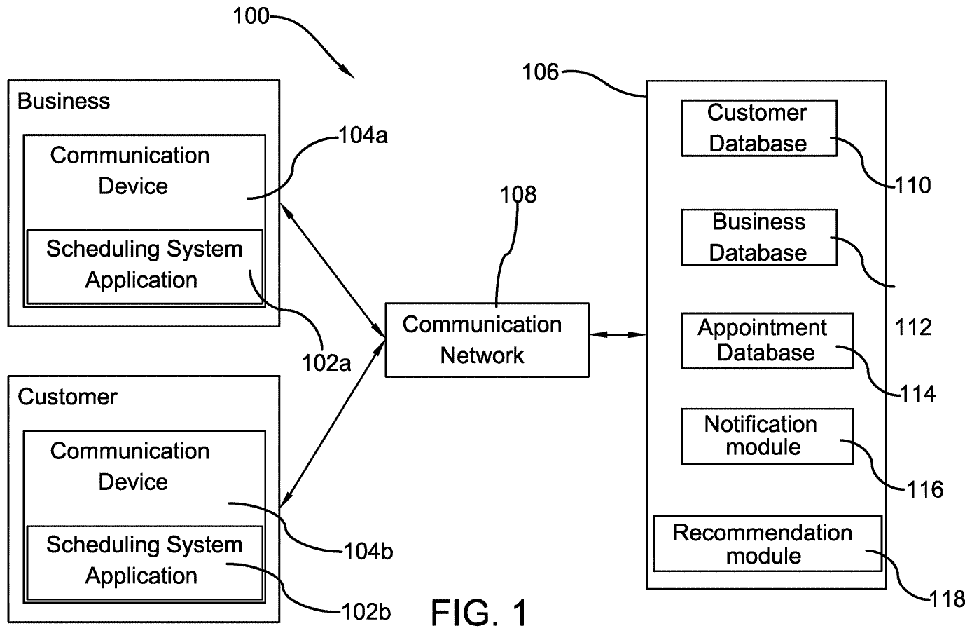

Referring initially to the drawings, FIG. 1 illustrates a schematic view of the appointment scheduling system of the present invention in accordance with the disclosed architecture. The appointment scheduling system 100 of the present invention is configured to provide customers and businesses with a system used for scheduling events and timeslots. The system 100 is also used by businesses for planning and creating an event, automatically notifying customers who are on a waitlist and particularly ensuring that empty timeslots are consistently filled with new customers. Customers are provided with the capability of booking or scheduling an appointment in a timeslot, canceling an appointment, rescheduling appointments, and more.

The system 100 is accessed by a business such as a service provider, for example, doctor, dentist, veterinarian, spa, barber, counsellor, and more using a computer-implemented appointment scheduling software application 102a on a computing device 104a. The functionality provided by the computer-implemented appointment scheduling software application 102a can also be provided using a website accessed using a URL on a web browser. Similarly, the system 100 is accessed by a customer using a computer-implemented rating system software application 102b on a computing device 104b. The software applications 102a, 102b may provide similar or different user interfaces and are configured to provide functionality enabling a business to create and plan events and a customer to perform book, cancel, and reschedule appointments. Preferably, the software applications 102a, 102b are essentially the same application and are configured to provide different interfaces based on a user being logged in either as a business or a customer.

The scheduling applications 102a, 102b are configured to connect to a server 106 using a communication network 108. The communication network 108 can be one or more types of wireless communication signals and/or systems, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, discrete multi-tone (DMT), Bluetooth (®), global positioning system (GPS), Wi-Fi, ZigBee (™), global system for mobile communication (GSM), 2G, 2.5G, 3G, 3.5G, 4G, 5G, 6G or the like.

The server 106 can be a centralized server, distributed server, cloud server or the like. The server 106 is configured to provide one or more web interfaces, user interfaces, and functionalities for managing appointments using a plurality of integrated software and hardware modules as described in the present disclosure. The server 106 includes a customer database 110 for storing customer profiles including name, address, contact details, previous appointments, favorite businesses, reviews and more. When a customer signs up on the system 100, a customer profile is created and is stored in the customer database 110. The customer database 110 uses uniquely identifying keys to identify each customer and retrieves a profile of the customer using the unique key.

A business database 112 is configured for storing business profiles of the businesses registered with the scheduling system 100. The business database 112 including business names, details of business, events, contact details, reviews, and more. When a business signs up on the system 100, a business profile is created and is stored in the business database 112. Similar to a customer record, each business is uniquely identified in the database 112 using one or more unique identifying keys.

An appointment database 114 is used for storing information of all active appointments and timeslots registered by the customers and businesses in the system 100. The appointment database 114 is also coupled to a notification module 116 for sending notifications to a business when a customer cancels or reschedules an appointment. The notification module 116 is also configured to send notifications to a customer kept on a waitlist for an appointment for a business as described later in the disclosure. The electronic notifications may be sent via the network 108 and may comprise emails, SMS text messages, MMS, instant messages, a push notification, integrated voice response (IVR) phone calls, and/or any other suitable automated notification type.

For recommending a business for appointments to customers, the server 106 has a recommendation module 118 that analyses past appointments of a customer and based on the type of business and preferred timeslots, recommendations of businesses and timeslots are provided to the customer. It should be noted that the server 106 can be a public, private, or hybrid cloud server. For providing necessary functionality, the server 106 can comprise one or more processors (e.g., CPUs or microprocessors), one or more memory units (e.g., RAM, ROM), non-volatile storage systems (e.g., hard disk drive systems), etc. The processor(s) and/or memory unit(s) may be implemented as integrated circuits (ICs).

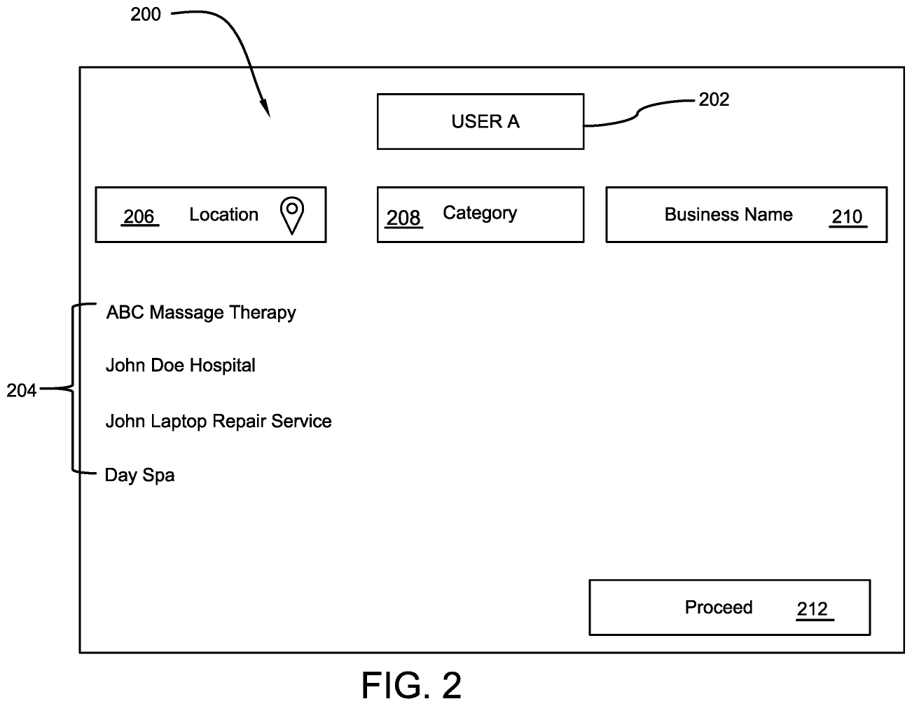

FIG. 2 illustrates an exemplary user interface/web interface that a customer might see while interacting with the software application in accordance with the disclosed architecture. As illustrated, User A 202 is logged in as a customer in the system 100 using the computer-implemented application. The user interface 200 displays a list 204 of businesses or service providers that the user 202 can choose from. Further, a location tab 206 enables the user to input a location or use the GPS to pin a location whereby the application displays a list of businesses near the location.

A category box 208 is used for inputting a category such as salon, spa, gym, doctor, dentist, veterinarian, and more, for displaying a list of businesses of the category. The category may be, for example, the type of service sought (hair stylist, fitness center, massage, health visit, etc.). In addition to the category, a business name or the name of a particular person who provides a sought-after service, or any other relevant key words can be input in the input box 210. The customer 202 can use one or more of the boxes 206, 208, 210 for locating a preferred service provider in the online scheduling application of the present invention. Once a business or a service provider is selected on the interface 200, a proceed button 212 is activated and is used by the customer 202 for proceeding with booking or scheduling an appointment.

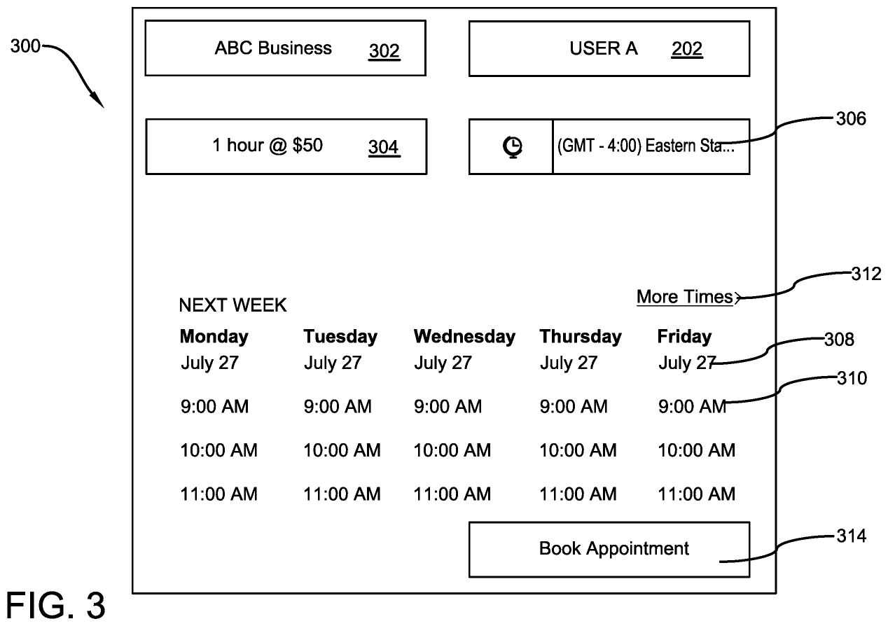

FIG. 3 illustrates another exemplary user interface/web interface displayed on the online scheduling application to a customer for booking or scheduling an appointment in accordance with the disclosed architecture. As illustrated, the user 202 selected the ABC Business 302 for booking or scheduling an appointment. Other details of the business such as address, contact information, and more may also be displayed along with the name in the preferred embodiment. A cost 304 associated with the appointment and a time zone 306 are also displayed for the customer 202. The time zone 306 can be changed to the current time zone of the customer 202.

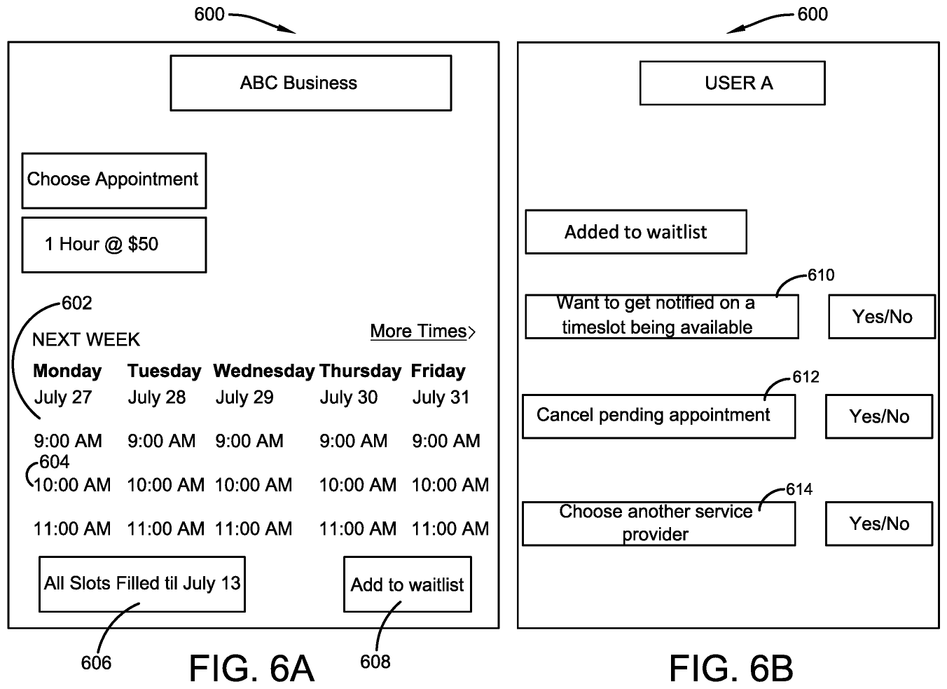

A calendar interface 308 along with the timeslots 310 is displayed on the user interface 300 that enables a user to select a specific timeslot for an appointment. Also, the user 202 can see date and time of any other days/weeks/months by clicking on the “more time” 312 icon. In situations where timeslots are not available, a notification will be displayed as illustrated in FIG. 6. It should be noted that the calendar interface can be in any form and further can be modified by the customer 202 as per the preferences.

Once a preferred date and timeslot are selected by the customer 202, then, “Book Appointment” 314 is activated and can be selected by a user for proceeding with the appointment booking or scheduling.

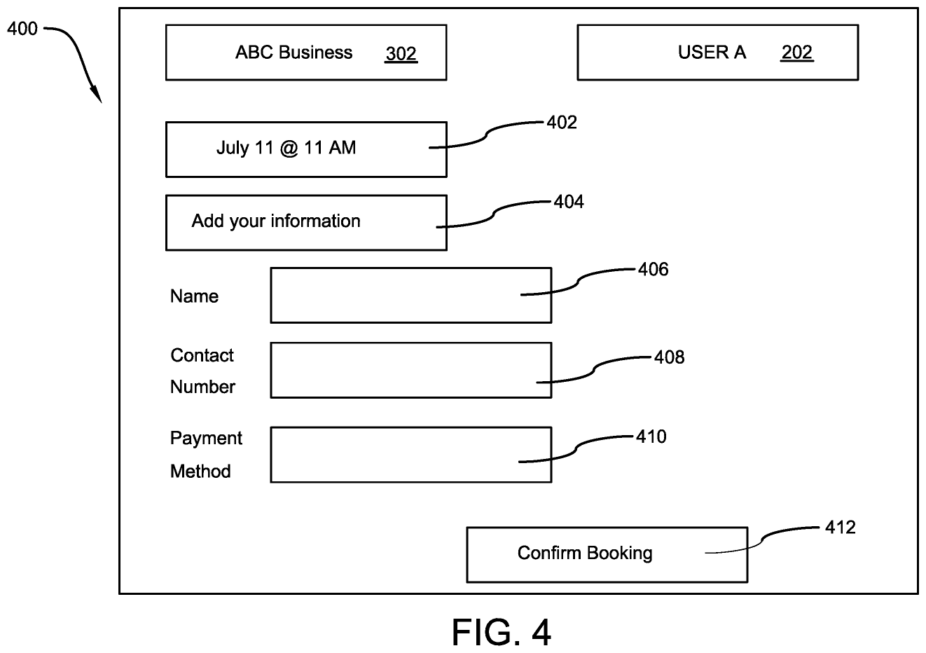

FIG. 4 illustrates an exemplary user interface of the online scheduling application for interaction with a customer to confirm an appointment booking or scheduling in accordance with the disclosed architecture. Continuing from FIG. 3, the user 202 selects an appointment time 402 (July 11@11 AM in the present embodiment). Then, for confirming the appointment, username is input in a username box 406. In one embodiment, the user's name can be auto filled from the profile of the user stored in the customer database of the server. Additional information is included using the contact number box 408, and the payment method box 410. Additional information tabs are activated when a user clicks on “Add your information” button 404.

An advantage of the system of the present invention is that the user can perform payment for the appointment using the application 102b and therefore, does not require to leave the application 102b. Further, the system 100 can have a commission from the payment to generate revenue. Once, the payment of the customer is verified, then, using the “Confirm Booking or scheduling” button 412, the appointment booking or scheduling is confirmed and is stored in the appointment database 114 of the system. It should be noted that once a booking or scheduling for a business is confirmed, a notification is sent to the business including customer name and booking or scheduling details.

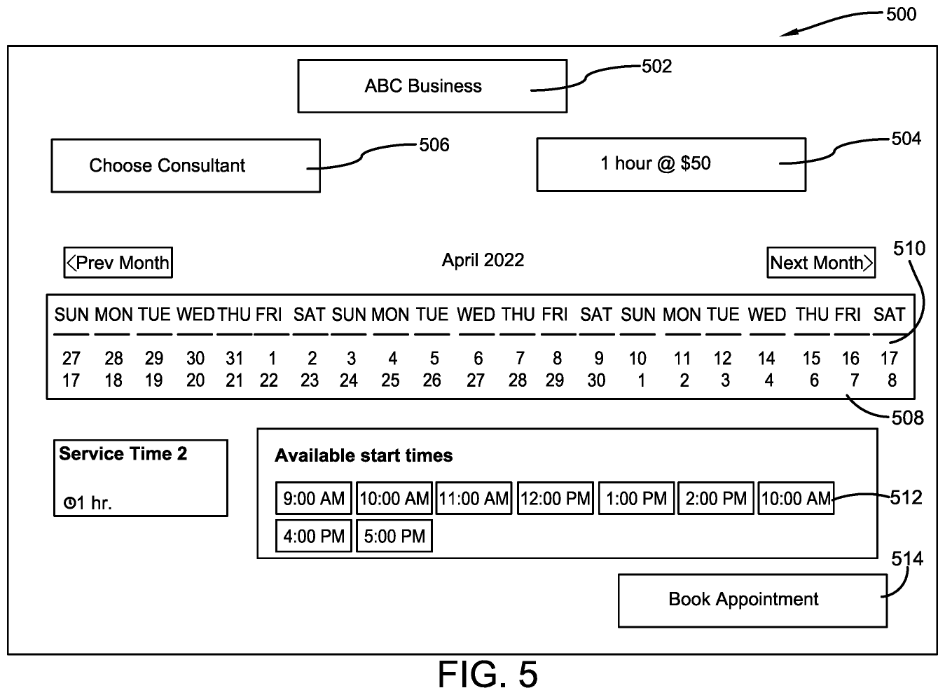

FIG. 5 illustrates another exemplary user interface of the application enabling a user to book an appointment timeslot in accordance with the disclosed architecture. The present embodiment illustrates a variant of the user interface 300 shown in FIG. 3. The user interface 500 displays the business name 502 selected by a user for booking or scheduling an appointment and a cost 504 of the appointment. In situations where there are multiple consultants, doctors, trainers, and more at the business 502, then, the choose consultant drop down menu 506 is used for selecting a specific service provider person.

Accordingly, a calendar display 508 displaying the dates 510 and available or empty timeslots 512 is displayed on the interface 500. It should be noted that only the available or empty timeslots are displayed in the calendar 508 and using a specific timeslot, an appointment can be booked by clicking on the “Book Appointment” button 514.

FIG. 6A illustrates an exemplary user interface providing capability of adding a customer to a waitlist for appointment booking or scheduling in accordance with the disclosed architecture. The exemplary user interface 600 displays a calendar 602 showing timeslots 604 and in case all the timeslots are filled up to a date, then, a message or notification 606 is displayed on the interface 600 indicating the unavailability of the timeslots. For enabling the user to add to a waitlist for booking or scheduling appointment, an “Add to waitlist” button 608 is displayed and when clicked, adds the user/customer to a waitlist for the appointment booking or scheduling for the business “ABC Business.” A notification is also sent to the business when a user adds to the waitlist.

FIG. 6B illustrates another user interface providing options for the customers to modify a pending appointment after being added to a waitlist in accordance with the disclosed architecture. When a customer is added to a waitlist for an appointment for a business, a first option 610 is displayed for enabling the customer to get notified when a timeslot for appointment becomes available. A second option 612 for canceling pending appointment is provided that enables a user to cancel the pending appointment. For providing the customer flexibility of choosing an appointment of another service provider for the same service, a third option 614 is provided for choosing another service provider.

It should be noted that the system 100 enables the business to receive notifications of a customer canceling a booking or scheduling, wanting to be notified for an available timeslot, and rescheduling of the appointment.

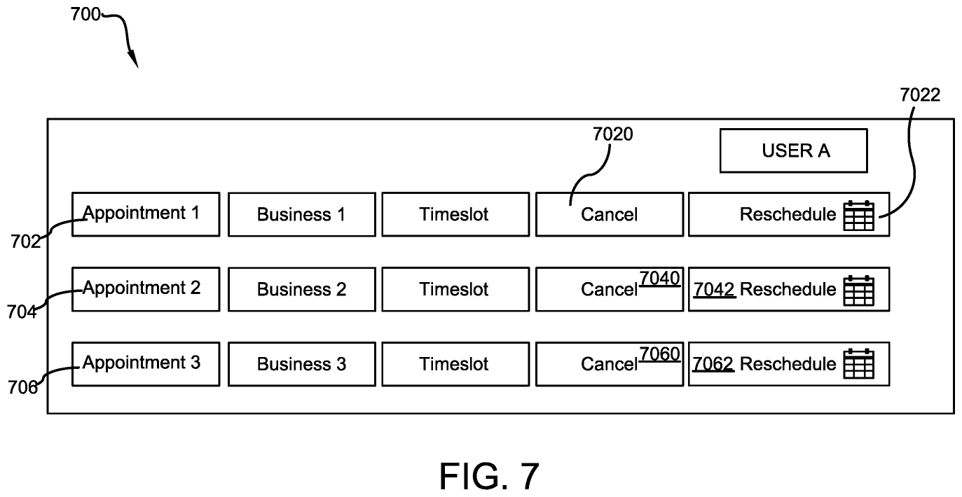

FIG. 7 illustrates an exemplary user interface of the online scheduling application enabling a customer to cancel and reschedule a booked appointment in accordance with the disclosed architecture. As illustrated, a customer can have a plurality of appointments 702, 704, 706 with same or different service providers using the application. The application enables the user to cancel any of the appointment using a corresponding cancel button. Similarly, the application enables the user to reschedule any of the appointments using a corresponding reschedule button. As shown as an example, first appointment 702 can be canceled using cancel button 7020 and rescheduled using reschedule button 7022. The second appointment 704 can be canceled using cancel button 7040 and rescheduled using reschedule button 7042. The third appointment 706 can be canceled using cancel button 7060 and rescheduled using reschedule button 7062.

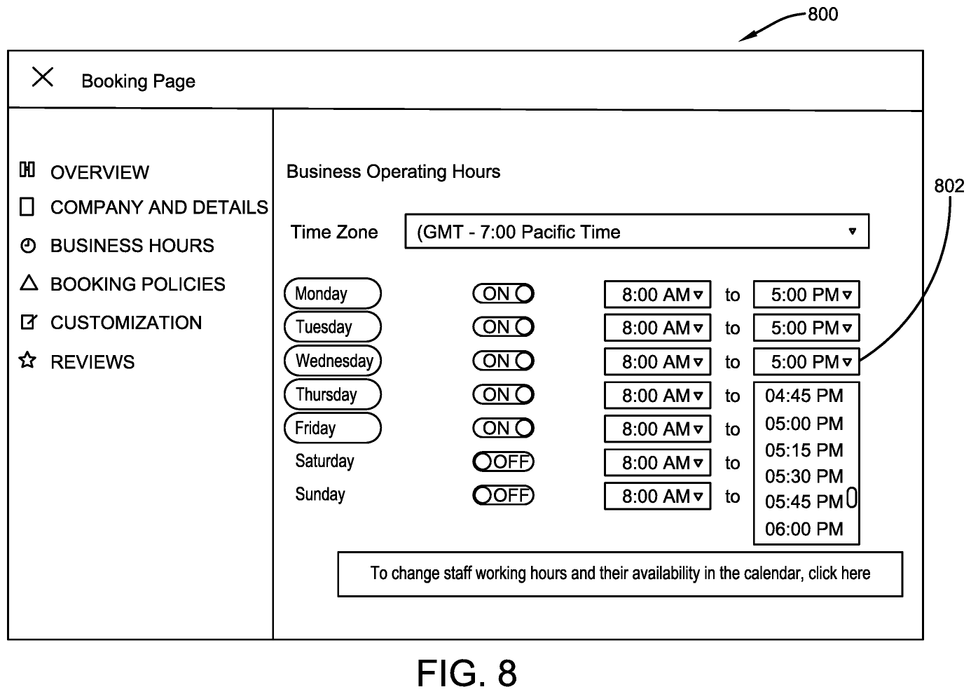

FIG. 8 illustrates an exemplary user interface shown by the application 102a for a business to set business hours for appointments in accordance with the disclosed architecture. As illustrated, in the present embodiment, the user interface 800 enables a business to set business hours for a day or for every day using booking or scheduling hours list 802. The business hours set by the business are displayed to customers for booking or scheduling timeslots for appointments. This interface 800 is useful for services that perform operations within specific time limits during the course of a day.

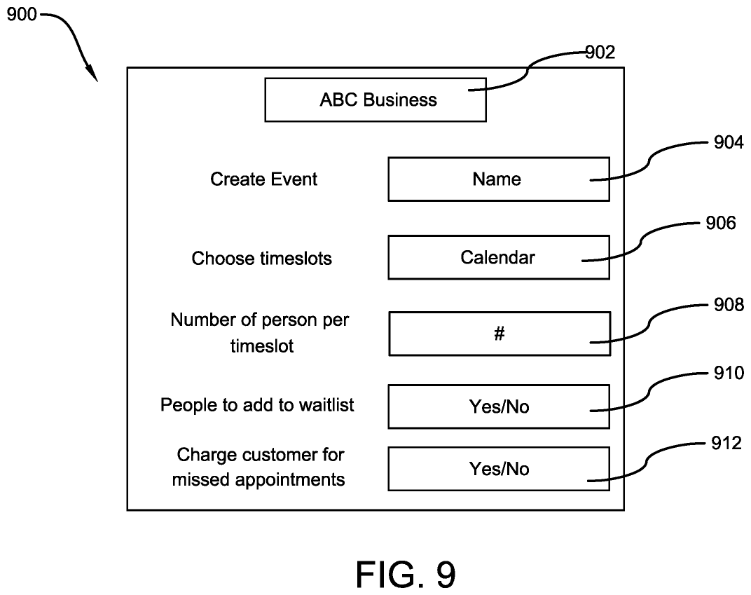

FIG. 9 illustrates another user interface for a user to interact with the online scheduling application for creating specific events and timeslots for appointments in accordance with the disclosed architecture. As illustrated, the user interface 900 displays the business name 902 operating the application. An event is created using the event name box 904 and timeslots are selected using the calendar 906. For enabling a limited number of individuals in a single timeslot, the business 902 puts an upper threshold on the number of individuals using the person count box 908. When a customer tries to book a timeslot after maximum number of customers have already booked the timeslot, the customer may be put on a waitlist when the “Individuals to add waitlist” option 910 is selected by the business. The option 910 can be enabled by a present default in the system of the present invention.

It should be noted that automatic scheduling system adds customers to a waitlist for a business, therefore, not enabling the business to lose customers. Further, the application enables the business to charge customers a penalty for missing an appointment. The feature of charging customers for missing appointments can be disabled by the business based on their preference using the binary option 912.

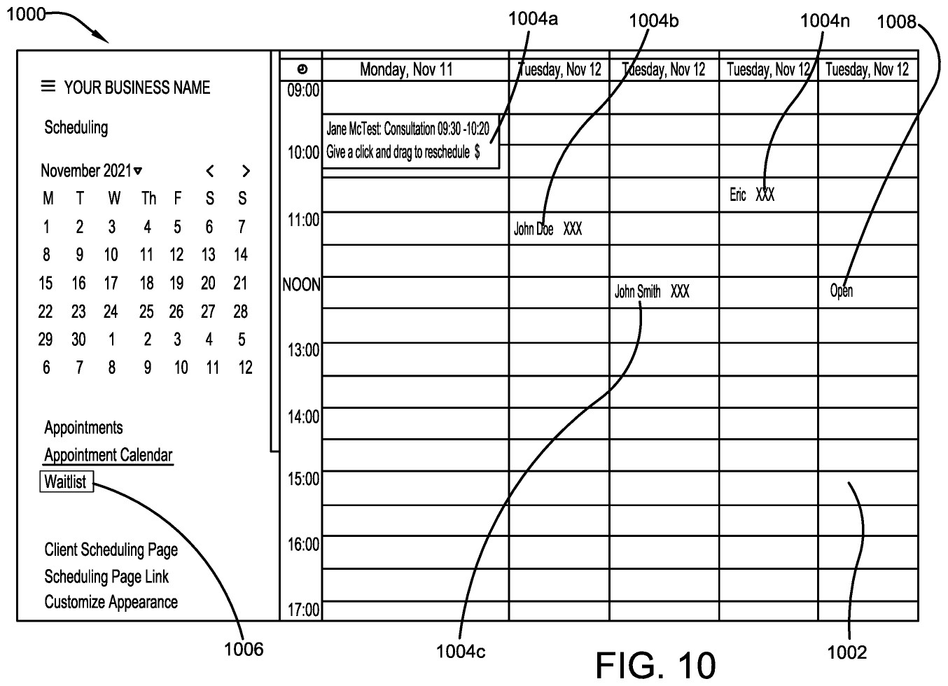

FIG. 10 illustrates a user interface for a business to view appointment calendar and status of customer appointments in accordance with the disclosed architecture. In the exemplary user interface 1000, the appointment calendar 1002 displays the appointments 1004a-n wherein each appointment details name of the customer and an optional contact detail. Further, a waitlist 1006 is displayed on the user interface 1000 that enables the business to select one or more customers from the waitlist to notify for one or more open appointment timeslots 1008. Accordingly, the selected users receive the notification of availability of open timeslots. This enables businesses to fill open timeslots easily and instantly. Notifying customers in waitlist about open timeslots can be performed automatically by the system without any user intervention.

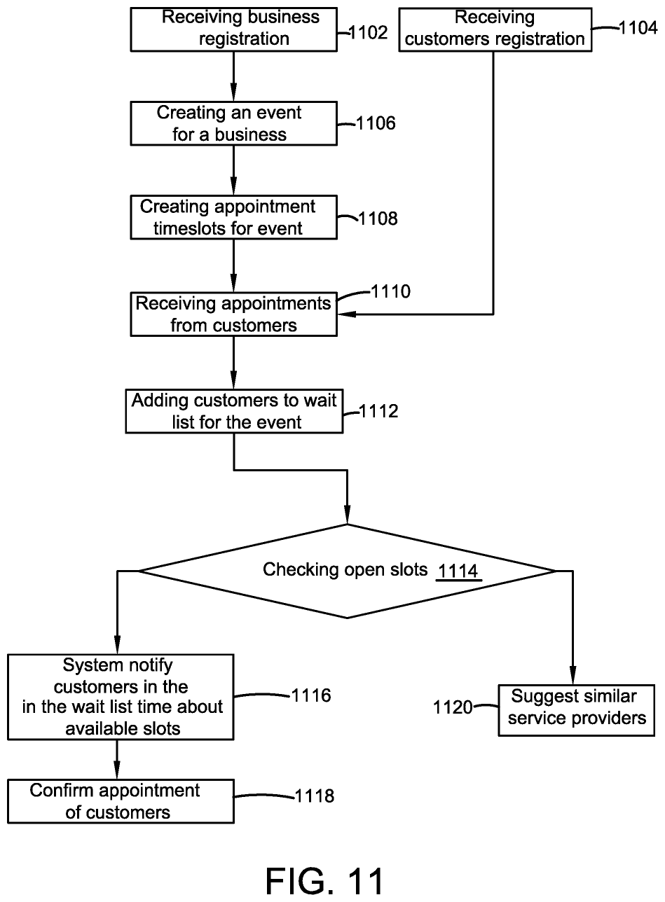

FIG. 11 illustrates a flow diagram depicting a process of working of the online scheduling system 100 of the present invention in accordance with the disclosed architecture. Initially, the system receives business registration (Step 1102) and customers registration (Step 1104). The businesses information is stored in the business database and the customers information is stored in the customer database. Then, based on the inputs received from a business, an event for the business is created (Step 1106). Then, for the created event, appointment timeslots are created which can be used by registered customers for booking or scheduling an appointment (Step 1108).

Based on the timeslots, appointment bookings or schedulings are received from customers by the system and the businesses are notified of the appointments (Step 1110). Further, the appointment calendars of the businesses also show the appointments. In situations where the timeslots are filled, the system adds the customers to a waitlist and notifies both customers and businesses about the waitlist (Step 1112).

The system checks for any open timeslots for a business when customers are added to the waitlist (Step 1114). In situations where any open timeslot is identified due to cancellation or reschedule of the confirmed booking or appointment, then, one or more customers of the waitlist are notified (Step 1116) and appointments of the customers are confirmed (Step 1118). In situations where open timeslots are not detected, then, the system may suggest similar service providers having available timeslots for booking or scheduling (Step 1120).

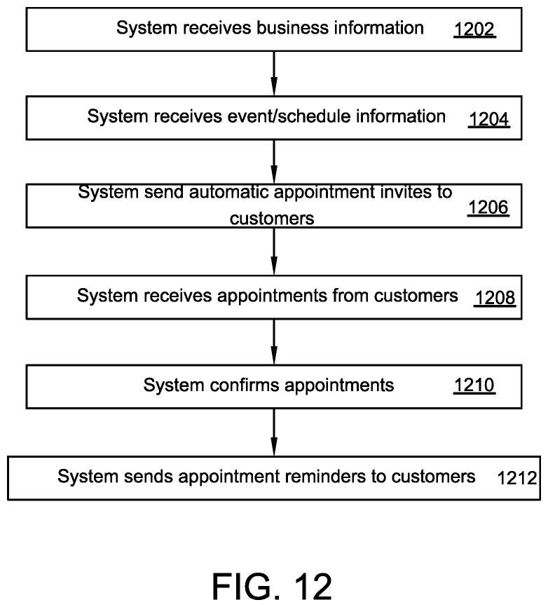

FIG. 12 illustrates a flow diagram depicting a process of appointment confirmation and reminders to customers in accordance with the disclosed architecture. Initially, the system receives a business registration including business information (Step 1202). Then, the system receives an event schedule information from the business (Step 1204). Once the appointment timeslots are scheduled, the system sends automatic invites to customers (Step 1206). The system then receives one or more bookings or schedulings for appointments from the customers (Step 1208).

The bookings or schedulings of the customers falling in the available timeslots of the business are confirmed by the system (Step 1210). When a booking or scheduling is confirmed, a notification is sent to both business and the customer. The system is configured to send appointment reminders to customers ensuring that the customers do not miss the appointment as missing the appointments may incur charges for the customers (Step 1212).

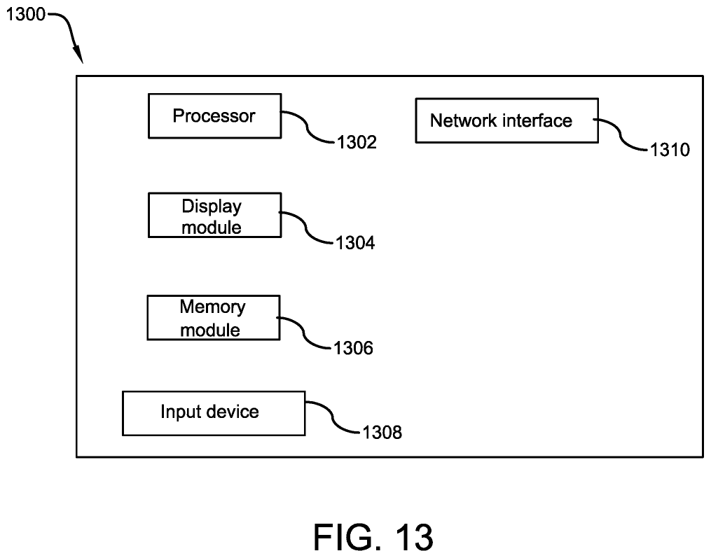

FIG. 13 depicts an exemplary computing device for implementing the online appointment scheduling application of the present invention in accordance with the disclosed architecture. Computing system 1300 may be implemented on a handheld device, smart phone, laptop, or desktop computer and more as described in FIG. 1. The computing system 1300 includes a processor 1302 communicatively coupled to one or more memory modules 1306. The processor 1302 executes computer-executable program code of the rating system application stored in a memory device 1306. Examples of the processor 1302 include a microprocessor, an application-specific integrated circuit (“ASIC”), a field-programmable gate array (“FPGA”), or any other suitable processing device. The processor 1302 can include any number of processing devices or cores, including a single processing device. The functionality of the computing device may be implemented in hardware, software, firmware, or a combination thereof.

The memory module 1306 includes any suitable computer-readable medium such as electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions.

The computing device 1300 executes program code that configures the processor 1302 to perform one or more of the operations described above with respect to FIGS. 2-7. The computing device 1300 also includes at least one network interface 1310. The network interface 1310 includes any device or group of devices suitable for establishing a wired or wireless data connection to one or more data networks. Non-limiting examples of the network interface 1310 include an Ethernet network adapter, a modem, or the like.

A display module 1304 is configured for displaying user interfaces of the application of the present invention and the input device 1308 can be used for submitting input to the application for processing by the processor 1302.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “online appointment scheduling system”, “appointment scheduling system”, “system”, and “online scheduling system” are interchangeable and refer to the online appointment scheduling system 100.

Notwithstanding the forgoing, the online appointment scheduling system 100 of the present invention can be of any suitable size and configuration as is known in the art without affecting the overall concept of the invention, provided that it accomplishes the above stated objectives. One of ordinary skill in the art will appreciate that the online appointment scheduling system 100 as shown in the FIGS. are for illustrative purposes only, and that many other configurations of the online appointment scheduling system 100 are well within the scope of the present disclosure.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in-whole or in-part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments may include devices and/or systems using one or more suitable Operating Systems, for example, Microsoft Windows, Microsoft Windows CE, Microsoft Windows Embedded, Microsoft Windows Mobile, Unix, iOS, Linux, Sun Solaris, Palm OS, J2ME, BREW, an OS used by BlackBerry device(s), or other suitable Operating Systems.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An appointment scheduling system comprising:
a computer-implemented appointment scheduling software application accessible by a business and a customer for determining a schedule;
a business communication device having a business scheduling system access;
a customer communication device having a customer scheduling system access;
wherein said business scheduling system access provides said business with the appointment scheduling system for scheduling appointments;
wherein said business scheduling system access automatically notifies waitlisted customers of empty timeslots in said schedule;
wherein said customer scheduling system access provides said customer with the appointment scheduling system for scheduling appointments, canceling appointments, and rescheduling appointments;
a customer database for storing customer profiles consisting of a name, an address, a contact detail, a previous appointment, a favorite business, and a review;
a business database for storing business profiles consisting of a business name, a business detail, an event, a contact detail, and a review; and
an appointment database for storing information of all active appointments and registered timeslots by said customer and said business.

2. The appointment scheduling system of claim 1, wherein said business is selected from a group of service providers consisting of a doctor, a dentist, a veterinarian, a salon, a gym, a spa, a health visit, a massage, a fitness center, a barber, a hair stylist, and a counsellor.

3. The appointment scheduling system of claim 1, wherein said computer-implemented appointment scheduling software application comprises a website accessed with a URL on a web browser.

4. The appointment scheduling system of claim 1, wherein said business scheduling system access and said customer scheduling system access connected to a server using a communication network selected from a wireless communication signal group consisting of a radio frequency (RF), an infrared (IR), a frequency-division multiplexing (FDM), an orthogonal FDM (OFDM), a time-division multiplexing (TDM), a time-division multiple access (TDMA), an extended TDMA (E-TDMA), a general packet radio service (GPRS), an extended GPRS, a code-division multiple access (CDMA), a wideband CDMA (WCDMA), a CDMA 2000, a discrete multi-tone (DMT), a Bluetooth (®), a global positioning system (GPS), a Wi-Fi, a ZigBee (™), a global system for mobile communication (GSM), a 2G, a 2.5G, a 3G, a 3.5G, a 4G, a 5G, and a 6G.

5. The appointment scheduling system of claim 4, wherein said server is selected from a group consisting of a centralized server, a distributed server, and a cloud server, and is configured to provide said business scheduling system access and said customer scheduling system access.

6. The appointment scheduling system of claim 1, wherein said appointment database comprises a notification module for sending business notifications to said business when said customer cancels or reschedules an appointment.

7. The appointment scheduling system of claim 6, wherein said notification module for sending customer notifications to said waitlisted customers kept on a waitlist for scheduling at least one of said empty timeslots.

8. The appointment scheduling system of claim 7, wherein said business notifications and said customer notifications sent through said communication network are selected from a group consisting of an email, an SMS text message, an MIMS, an instant message, a push notification, and an integrated voice response (IVR) phone call.

9. The appointment scheduling system of claim 1, further comprising a recommendation module for analyzing past appointments of said customer, wherein based on said past appointments said recommendation module recommends said business and said empty timeslots to said customer.

10. The appointment scheduling system of claim 1, wherein said recommendation module analyzes past appointments of said customer, wherein based on said past appointments said recommendation module recommends another business to said customer.

11. The appointment scheduling system of claim 1, wherein said customer scheduling system access provides for scheduling appointments, canceling appointments, and rescheduling appointments of a plurality of businesses.

12. An appointment scheduling system comprising:
a computer-implemented appointment scheduling software application accessible by a business and a customer for determining a schedule;
a business communication device having a business scheduling system access;
a customer communication device having a customer scheduling system access;
wherein said business scheduling system access provides said business with the appointment scheduling system for scheduling appointments;
wherein said business scheduling system access automatically notifies waitlisted customers of empty timeslots in said schedule;
wherein said customer scheduling system access provides said customer with the appointment scheduling system for scheduling appointments, canceling appointments, and rescheduling appointments;
a customer database for storing customer profiles consisting of a name, an address, a contact detail, a previous appointment, a favorite business, and a review;
a business database for storing business profiles consisting of a business name, a business detail, an event, a contact detail, and a review; and
further wherein said scheduling appointments comprise selecting a date and said empty timeslot for at least one said scheduling appointment and making payment for said at least one said scheduling appointment.

13. The appointment scheduling system of claim 12, wherein said computer-implemented appointment scheduling software application collects a commission from said payment.

14. The appointment scheduling system of claim 13, wherein said appointment database comprises a notification module for sending business notifications to said business when said customer cancels or reschedules an appointment.

15. The appointment scheduling system of claim 14, wherein said notification module for sending customer notifications to said waitlisted customers kept on a waitlist for scheduling at least one of said empty timeslots.

16. The appointment scheduling system of claim 15, wherein said business notifications and said customer notifications sent through said communication network are selected from a group consisting of an email, an SMS text message, an MIMS, an instant message, a push notification, and an integrated voice response (IVR) phone call.

17. The appointment scheduling system of claim 13, further comprising a recommendation module for analyzing past appointments of said customer, wherein based on said past appointments said recommendation module recommends said business and said empty timeslots to said customer.

18. The appointment scheduling system of claim 17, wherein said recommendation module analyzes past appointments of said customer, wherein based on said past appointments said recommendation module recommends another business to said customer.

19. An appointment scheduling system comprising:
a computer-implemented appointment scheduling software application accessible by a business and a customer for determining a schedule;
a business communication device having a business scheduling system access;
a customer communication device having a customer scheduling system access;
wherein said business scheduling system access provides said business with the appointment scheduling system for scheduling appointments and waitlisting customers;
wherein said customer scheduling system access provides said customer with the appointment scheduling system for scheduling appointments, canceling appointments, and rescheduling appointments;
a customer database for storing customer profiles consisting of a name, an address, a contact detail, a previous appointment, a favorite business, and a review;
a business database for storing business profiles consisting of a business name, a business detail, an event, a contact detail, and a review; and
further wherein said scheduling appointments comprise selecting a date and an empty timeslot for at least one said scheduling appointment.

20. The appointment scheduling system of claim 19, wherein said business scheduling system access automatically notifies said waitlisted customers of said empty timeslots in said schedule.
